(19) United States
(12) Patent Application Publication
(10) Pub. No.: US 2008/0209031 A1
(43) Pub. Date: Aug. 28, 2008

(54) Method of collecting and managing computer device information

(75) Inventors: Wei Zhu, Tianjin (CN); Zhi-Nan Guo, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/709,240

(22) Filed: Feb. 22, 2007

(51) Int. Cl. G06F 15/16

(52) U.S. Cl. 709/224

(57) ABSTRACT

A method of collecting and managing computer device information is provided to collect, analyze, and manage device information of a plurality of client computers in a network through a server/client application program. The method includes installing and running a client server application program on client computers in a network and installing and running a server management application program on a server in the network; after each of the client computer is booted, selecting a corresponding data acquisition method according to the type of the operating system of the client computer, so as to perform data acquisition on the device information of the computer in real time; analyzing and summarizing the acquired device information and then sequentially assorting and storing the information; monitoring and recording the changes of the information in real time; and sending the stored information and the changes thereof to the server for statistical analysis and tracking management.

### BACKGROUND OF THE INVENTION

1. Field of Invention

The present invention relates to a method of acquiring computer device information, and more particularly to, a method of selecting a corresponding data acquisition method according to the type of the operating system of a computer, so as to perform data acquisition, analysis and storage, and remote management in real time on the computer device information.

2. Related Art

Currently, in an era of ever-progressing “Information Technology”, various information technologies are developing at a tremendous pace, with a result that information devices are updated more and more frequently. With regard to computer products, there are uncountable hardware devices, and new products emerge one after another. Thus, how to efficiently manage the computer products has become an issue that enterprises have to face. The increasing/decreasing number of the computer device is the most common asset change in enterprise informatization application, and it has become a key point and a difficult point in the current enterprise asset management to inspect and acquire the device information of a computer and software/hardware devices thereof and count the usage, damage, or loss of the computer devices.

At present, there are many ways to obtain computer device information with matured technologies and uncomplicated realization processes. However, these technologies usually have a single function, i.e., only suitable for a single or specific operating system. For example, in Windows and Linux operating systems, the device information is acquired in a different way, and different realization methods should be selected aiming at the individual system environment. Meanwhile, the technologies are only data acquisition methods for obtaining the device information and these functions are far from satisfactory to practical demands in the computer device asset management of the enterprises.

Most of the currently available methods of acquiring computer device information are only applied in a single machinery or system environment to perform the acquisition and statistics on the device information. Or alternatively, even though the device information is obtained, it still need be assorted, counted, and analyzed manually, instead of being summarized and counted automatically. Prior arts have provided various data acquisition tools or acquisition methods of obtaining computer device information, including directly obtaining the computer device information from a driver; obtaining the computer device information by a Windows Management Instrumentation (WMI) standard; obtaining the computer device information by an Intelligent Platform Management Interface (IPMI) standard; and obtaining the computer device information by a standard Application Programming Interface (API) function. However, the acquisition tools or the acquisition methods of the computer device information in the prior arts have their own limitations in usage.

The WMI standard provides a standard basic structure to monitor and manage system resources, and allows a system manager to monitor and control the system by an instruction file or an application program of a partner manufacturer. Such a process is realized in a manner that the computer device information which meets the specification and can be identified by the WMI is obtained through WMI interface call provided by the Windows system. However, such a method is only applicable in the Windows system environment.

The IPMI standard is a specification standard for intelligently managing the computer system. The IPMI standard was proposed by Intel, DELL, HP, and NEC in 1998, which provides a cross-platform standard interface to monitor the situations inside the computer system, such as the power supply, temperature, voltage, and fan speed, and sends an event to inform the system manager of the current situation in the system. The system management may be implemented on different server system hardwares by using the interface standard design, so as to realize the centralized management of different system platforms (available in both the Windows system and the Linux system). However, firstly, the hardware devices of the computer must meet the specification requirements, and secondly, the hardwares of the computer must support the driver of the IPMI. In fact, many machines do not support the specification standard and thus the IPMI is merely applicable in a small scope.

The API is an interface communicating with other system programs by a single application program. The method of obtaining the computer device information through the standard API function is the mostly basic general method and applicable in the Windows and Linux operating systems. However, the API has the following disadvantages. The API is complicated in usage and difficult to master, and the obtained device information is usually limited and single, so the API must be used repeatedly and cannot support new devices in time.

The analysis of a device table file is the most common device information acquisition method in the Linux system. In the Linux system environment, all device information is stored in file directories, such as /etc and /dev, in the form of files, and desired device information may be obtained through analyzing the contents and structures of the files. However, such a method is only applicable in the device information acquisition in the Linux system environment. Therefore, the application range of the device table is too narrow.

In view of the above, the single computer device information acquisition methods in the prior arts cannot satisfy the practical requirements of enterprises to perform data acquisition and effective management on computer device assets. Therefore, a method of performing data acquisition and effective management on all computer device information of various operating system platforms is urgently to be provided.

### SUMMARY OF THE INVENTION

In order to solve the problems and defects in the aforementioned prior arts, the present invention is directed to a method of collecting and managing computer device information. Data acquisition, analysis and storage, and remote management are performed on the device information of a plurality of client computers in normal operation in a network through a server/client application program.

The method of collecting and managing computer device information comprises: installing and running a client server application program on a plurality of client computers in the network with a server/client network architecture and installing and running a server management application program on a server in the network; after the operating system of each of the client computers being booted, the client server application program selecting a corresponding data acquisition method according to the type of the operating system of the client computer and the practical situation of the computer devices, so as to perform data acquisition on the device information of the client computer in real time; analyzing and summarizing the acquired device information through the client server application program and then sequentially assorting and storing the information according to the acquisition time and type of the device information; monitoring and determining in real time whether the device information is changed through the client server application program, and recording and storing the changes of the device information; and after each of the client computers receives a request command from the server, sending the stored device information of the client computer and the changes thereof to the server, so as to perform statistical analysis and tracking management on the device information of each of the client computers in the network through the server management application program.

Furthermore, the method of collecting and managing computer device information provided by the present invention further comprises: when the client server application program monitors a change of the device information, feeding back the change of the device information to the manager in response to the request from the server by sending a trap alert.

In view of the above, the present invention has the advantage as follows.

By using the method of collecting and managing the computer device information provided by the present invention, the manager of the computer devices may not only collect the device information of a local computer, but also send commands to remote machines to collect the computer device information via the network. Besides, the manger may select a corresponding data acquisition method according to the type of the operating system of each of the client computers and the practical situation of the computer devices, so as to perform data acquisition in real time on all effective device information of all client computers. In this manner, the coverage of the data acquisition is broader.

Furthermore, after the manager receives the effective computer device information, the acquired device information is automatically analyzed and summarized by using the method provided by the present invention and then sequentially assorted and stored according to the acquisition time and type of the device information, and the change of the device information can be monitored and learned about effectively in real time, so as to perform statistical analysis and tracking management on the device information in an effective way. As a result, the computer device asset is managed more simply and conveniently, thereby greatly saving man power and material resources consumed by the manual operation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a flow chart of a method of collecting and managing computer device information according to the present invention;

FIG. 2 is a system block diagram of the server/client network architecture employed by a method of collecting and managing computer device information according to the present invention; and

FIG. 3 is a flow chart of the information acquisition process in a method of collecting and managing the computer device information according to the present invention.

### DETAILED DESCRIPTION OF THE INVENTION

Preferred embodiments of the present invention will be illustrated in detail as follows.

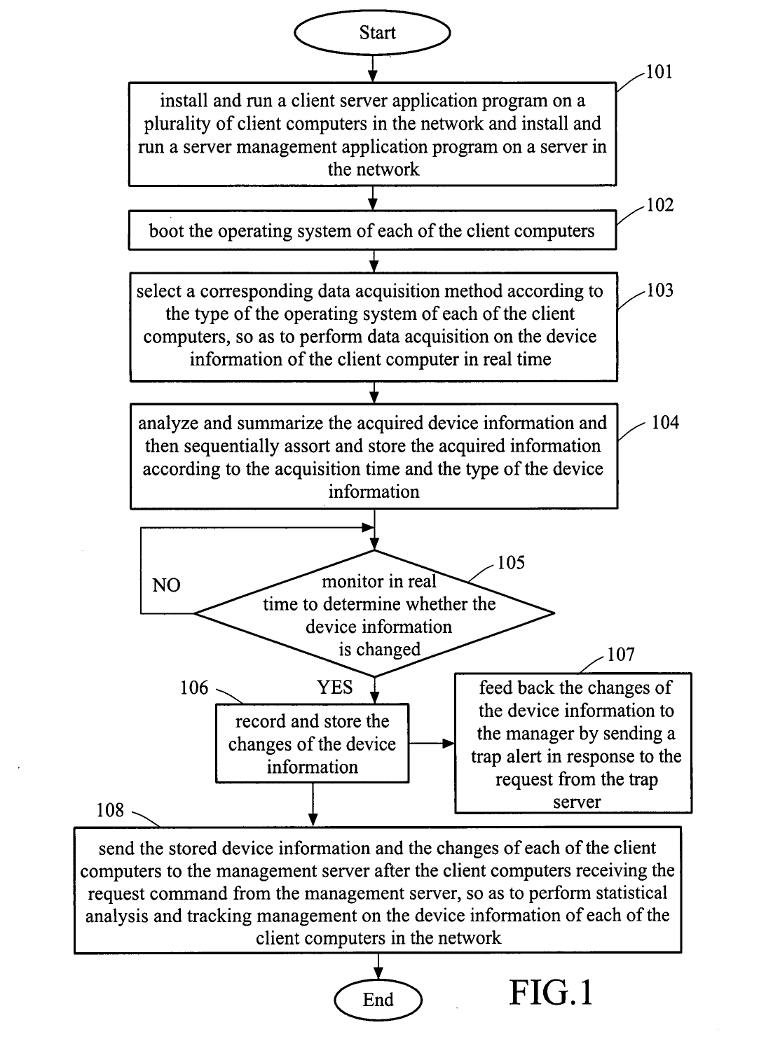

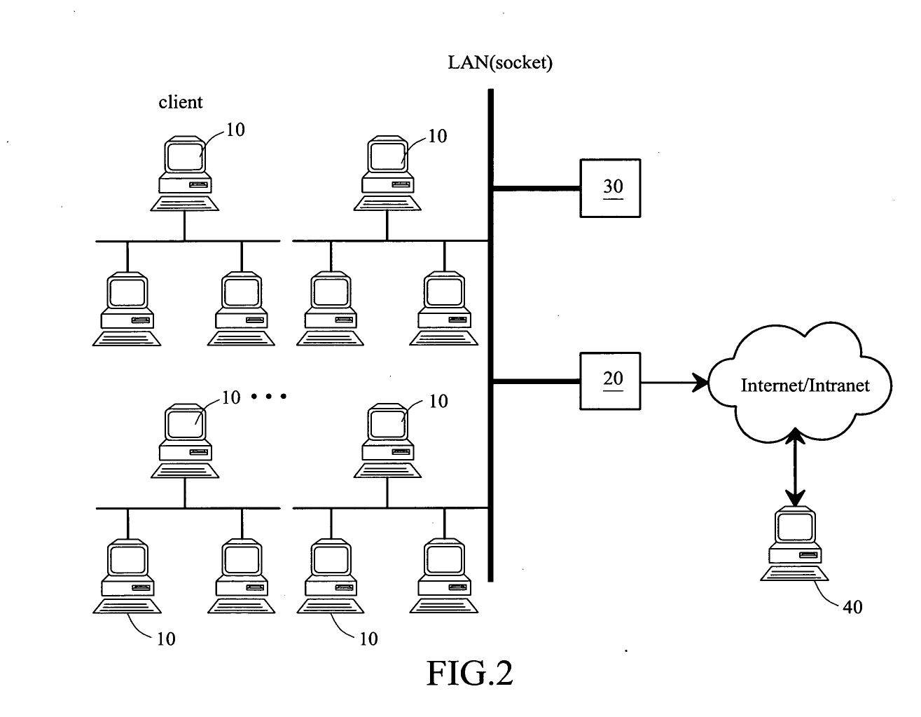

Referring to FIGS. 1 and 2, FIG. 1 is a flow chart of a method of collecting and managing computer device information according to the present invention, and FIG. 2 is a system block diagram of a server/client network architecture employed by the method of collecting and managing computer device information according to the present invention. As shown in FIGS. 1 and 2, the method of collecting and managing computer device information provided by the present invention is used to perform data collection, analysis and storage, and remote control on the device information of a plurality of client computers 10 in normal operation in a network through a server/client application program. The method of the present invention includes the following steps.

A client server application program is installed and run on the plurality of client computers 10 in a local area network (LAN) having a server/client network architecture, and a server management application program is installed and run on a management server 20 in the network (Step 101).

After the operating system of each of the client computers 10 is booted (Step 102), the client server application program selects a corresponding data acquisition method according to the type of the operating system of each of the client computers 10 and the practical situation of the computer devices, so as to perform data acquisition in real time on the device information in each of the client computers 10 (Step 103).

Through the client server application program, the acquired device information is analyzed and summarized and then sequentially assorted and stored in a database according to the acquisition time and the type of the device information (Step 104).

Whether the device information is changed is monitored and determined in real time through the client server application program (Step 105). During each poll round, when the device information obtained in real time is changed compared with the device information stored in the database, the specific time at the moment, detailed description of the changes of the device information, and other data are recorded and stored in the database (Step 106). If the device information is not changed, return to Step 105 to continue monitoring the changes of the device information.

After the client server application program monitors a change of the device information and records and stores the change of the device information, in response to a request of a trap server 30, the change of the device information is fed back to the manager by sending a trap alert (Step 107). The method of sending the trap alert, that may have four kinds of alerting methods, includes: sending an Email according to a provided sending address and a mail server, sending a simple network management protocol (SNMP) message according to a provided Internet protocol (IP) sending address and a port, sending a mobile phone short message according to a provided mobile phone number, and recording (i.e., writing a system log) in a register table or a system log.

Moreover, after each of the client computers 10 receives the request command sent from the management server 20, the stored device information of each of the client computers 10 and the changes thereof are sent to the management server 20, so as to perform statistical analysis and tracking management on the device information of each of the client computers 10 in the network through the server management application program (Step 108). The system manager sends a remote device query request to the client via the Internet or the Intranet by a console 40 and the management server 20 (the remote device query request supports command lines and web services), and after the management server 20 counts, analyzes, and stores all the received device information (including the information of one or more devices in the network) of each of the client computers 10, all the device information of the client and the changes thereof are clearly displayed by means of visualization (i.e., displaying a visual figure and a complete report to the manager or user).

The method of collecting and managing the computer device information provided by the present invention has an important feature which is illustrated as follows. The user may collect the device asset information of any number of remote client computers from a specific server, and the server application program installed in the client computers records the changes of the device assets regularly, and assorts and summarizes the data sequentially according to the type of the devices and the time of data collection, thereby obtaining an effective and sequential data report and storing the data report in the database. Then, the server sends a command for querying the device asset information to each of the remote client computers by sending a socket request packet. After receiving the query command, each of the client computers organizes the data of the device information according to the query content in the command and sends the organized data back to the server by means of an Extensible Markup Language (XML) data stream (the XML is a sub-set of the Standard Generalized Markup Language (SGML) and mainly used to enable the generalized SGML to provide services, receive and process data in the network like the HyperText Markup Language (HTML)). Afterward, the management application program in the server analyzes and summarizes the asset information of the client computer devices received from a remote end, and then organizes and assorts the data into a visual and effective form to be displayed to the manger or user. Many displaying methods are available. For example, the data is displayed in a web page and the manager or user learns the detailed asset information report and observes the historical changes of the assets by a network browser; the asset information report is sent to a mail box specified by the manager or user regularly by sending an Email; and furthermore, the manager or user is reminded of the changes of the device assets by sending a mobile phone short message or event alert. As such, the manager or user may not only monitor and learn about the long-term change course of the device assets comprehensively and effectively, but also learn about the changes of the device assets in time, so as to simplify and facilitate the management on the computer device assets, thereby greatly saving man power and material resources consumed by the manual operation.

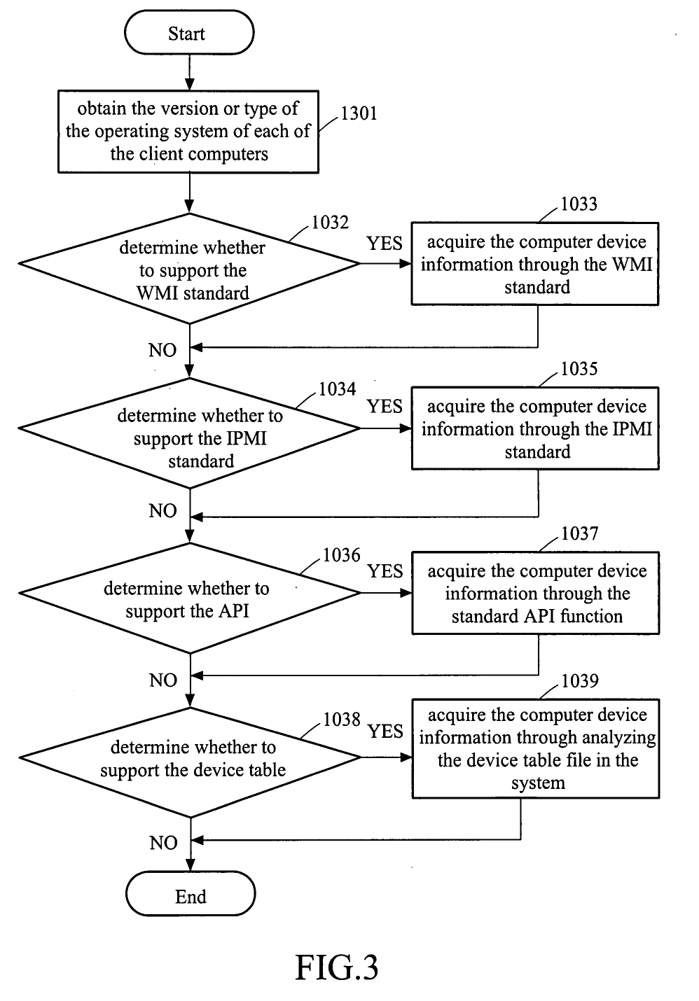

Referring to FIG. 3, a flow chart of the information acquisition process in the method of collecting and managing the computer device information according to the present invention is shown. As shown in FIG. 3, in the aforementioned method, the step of the client server application program selecting a corresponding data acquisition method according to the type of the operating system of each of the client computers and the practical situation or the computer devices, so as to perform data acquisition on the device information of the client computers in real time (Step 103) further includes:

obtaining the version or type of the operating system of each of the client computers (Step 1031);

determining whether to support the WMI standard (Step 1032), and if yes, acquiring the computer device information through the WMI standard (Step 1033) and then proceeding to Step 1034, and otherwise, proceeding to Step 1034 directly;

determining whether to support the IPMI standard (Step 1034), and if yes, acquiring the computer device information through the IPMI standard (Step 1035) and then proceeding to Step 1036, and otherwise, proceeding to Step 1036 directly;

determining whether to support the API (Step 1036), and if yes, acquiring the computer device information through the standard API (Step 1037) function and then proceeding to Step 1038, and otherwise, proceeding to Step 1038 directly; and

determining whether to support the device table (Step 1038), and if yes, acquiring the computer device information through analyzing the device table file in the system (Step 1039) and then finishing the data acquisition of the computer device information, and otherwise, finishing the data acquisition of the computer device information.

In the data acquisition method provided by the present invention, the critical technical problem to be solved for the data acquisition of the device information is to appropriately employ the most reasonable and effective data acquisition method to accurately obtain the detailed device information of each of the client computers regardless of the type of the operating system. If a completely specific novel device is employed and the information of the device cannot be effectively obtained by all the data acquisition methods provided by the present invention, the device is neglected and the data acquisition of the device is ended. Of course, the data acquisition methods provided by the present invention cover the data acquisition methods in the Windows and Linux operating systems. The device information acquired each time is stored in the database to be compared with the device information obtained next time, so as to determine whether the device information is changed.

In practical application of managing the device assets of an enterprise, the device assets in a computer often need to be counted. Except that idle devices stored in a storeroom may be counted easily, it is difficult to acquire, count, and manage the data of each of the devices at work, and even the user is unsure of what devices are assembled in a computer. Furthermore, it is unpractical to disassemble the device for inspection. The method of the present invention is just implemented to effectively satisfy the requirements of the enterprise on data collection, statistical analysis, and tracking management of the computer device assets.

### EMBODIMENT 1

It is unavoidable that each enterprise must inventory the device assets at the end of the year, and at each time of inventory, plenty of man power and material resources will be consumed. Once the method of collecting and managing the computer device information provided by the present invention is employed, the aforementioned task will be finished more easily. The device manager may implement the following operations (under the precondition that all devices to be inventoried must be in the network and installed with the client server application program of the method provided by the present invention).

Firstly, the server sends a query command to the network to require each of the client server application programs to send the current device list of the local computer and the data of the changes of the devices in the current year to the server.

Then, after receiving a query command, each of the clients immediately finds the information list of the current devices from the database and the data of the changes of the devices during a specified time period and forms the above data into two lists. Then, each of the clients marks the two lists with an identifier of the local computer and sends the two lists to the server requesting for query in a format of the XML data stream. Meanwhile, the client server application program still continues to perform data acquisition and device monitoring process by itself and runs when the system is booted. The data acquisition and device monitoring process are performed automatically without any control. The device information and the changes thereof are automatically stored in the database in real time for the next query request from the server.

Finally, after receiving the device information and the changes thereof from the client computers, the server analyzes, summarizes, and stores the device information in the database of the server. In this manner, the statistical work of the current device assets of the enterprise is completed after the data is integrated with the idle device information. Meanwhile, the enterprise manager can learn about the changes in all the devices of any computer this year (for example, a hard disk device is added sometime, and a 100 MB network card is removed to be replaced with a 1000 MB network card). Furthermore, the tracking management is performed on a specific device according to all the device information in the database (for example, a hard disk device is allocated and installed on one computer sometime and then allocated and installed on another computer sometime, thereby clearly reflecting the allocation and service condition of the device assets), so as to find the current service position of the device. In this manner, the statistical work of the device assets which is considered complicated, time and energy consuming before can now be finished easily and rapidly.

### EMBODIMENT 2

After the computer devices of the enterprise have been used for a period of time, the original purchased internal memory is not enough for usage and needs to be increased. Therefore, the device manager must count and analyze the computer devices to determine how to update the internal memory.

Firstly, according to the requirements of the manager, the management API of the server sends a request command of collecting the information of the internal memories to all the devices of the client computers in the network.

Then, after receiving the request command, each of the client computers in the network sends the device information of the internal memories in the local computer to the server in a format of the XML data stream. The device information is the complete internal memory information including computer information of the internal memories, the quantity of the slots of the internal memories in the motherboard, the number of the installed internal memories, and the model and capacity of each of the internal memories.

Subsequently, the server receives and assorts the internal memory information sent from each of the client computers in the network according to each of the client computers, lists the current internal memory situations of each of the client computers, and displays the internal memory situations directly by means of visualization. As such, the manager can easily figure out which client computers have the internal memories that should be upgraded.

Finally, an upgrade solution is further provided for the manager for reference by using the server management application program. More specifically, the statistical work is performed according to the type and slots of the internal memories and the internal memories with the same type are assorted and displayed. In this manner, the manager may clearly know how to allocate the memory devices. For example, two internal memories with a capacity of 256 MB are allocated to a computer with two or more idle slots. As for a computer device with only one idle slot, an internal memory with a capacity of 512 MB may be purchased or allocated. Thus, the previous complicated device update or upgrade becomes much easier.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of collecting and managing computer device information, used to perform data collection, analysis and storage, and remote management on device information of a plurality of client computers in normal operation in a network through a server/client application program, the method comprising:
installing and running a client server application program on a plurality of client computers in a network having a server/client network architecture, and installing and running a server management application program on a server in the network;
selecting a corresponding data acquisition method by the client server application program according to type of the operating system of the client computer after an operating system of each of the client computers is booted, so as to perform data acquisition on device information of the client computer in real time;
analyzing and summarizing the acquired device information through the client server application program and then sequentially assorting and storing the device information according to an acquisition time and type of the device information;
monitoring and determining in real time whether the device information is changed through the client server application program, and recording and storing changes of the device information; and
sending the stored device information of the client computer and the changes thereof to the server after each of the client computers receives a request command from the server, so as to perform statistical analysis and tracking management on the device information of each of the client computers in the network through the server management application program.

2. The method of collecting and managing computer device information as claimed in claim 1, further comprising:
feeding back the change of the device information to a manager in response to a request from the server by sending a trap alert when the client server application program monitors a change of the device information.

3. The method of collecting and managing computer device information as claimed in claim 2, wherein a manner of sending the trap alert comprises four ways: sending an Email, sending a simple network management protocol (SNMP) message, sending a mobile phone short message, and writing a system log.

4. The method of collecting and managing computer device information as claimed in claim 1, wherein the data acquisition method is a method of obtaining computer device information through a Windows Management Instrumentation (WMI) standard.

5. The method of collecting and managing computer device information as claimed in claim 1, wherein the data acquisition method is a method of obtaining computer device information through an Intelligent Platform Management Interface (IPMI) standard.

6. The method of collecting and managing computer device information as claimed in claim 1, wherein the data acquisition method is a method of obtaining computer device information through a standard Application programming Interface (API) function.

7. The method of collecting and managing computer device information as claimed in claim 1, wherein the data acquisition method is a method of obtaining computer device information through analyzing a device table file in system.

8. The method of collecting and managing computer device information as claimed in claim 1, wherein the device information of the client computers and the changes thereof are stored in a database.
